(19) United States
(12) Patent Application Publication
(10) Pub. No.: US 2025/0127307 A1
(43) Pub. Date: Apr. 24, 2025

(54) ATTACHMENT SYSTEM FOR PATIENT SUPPORT APPARATUS

(71) Applicant: Hill-Rom Services, Inc., Batesville, IN (US)

(72) Inventors: Taylor Vohland, Batesville, IN (US); Olivia Gubitose Boyce, Cincinnati, OH (US)

(21) Appl. No.: 18/916,028

(22) Filed: Oct. 15, 2024

Related U.S. Application Data
(60) Provisional application No. 63/591,769, filed on Oct. 20, 2023.

(51) Int. Cl. A47C 21/02; A61G 7/05

(52) U.S. Cl. CPC A47C 21/026; A61G 7/05

(57) ABSTRACT

A support apparatus includes an upper frame having an upper support surface and first and second side surfaces. A surface assembly includes an outer ticking, first straps extending from the outer ticking proximate to a head end, second straps extending from the outer ticking proximate to a foot end, and a strap connector coupled to a distal end of each of the first and second straps. Mating connectors are coupled to at least one of the upper frame and the outer ticking. The first and second straps extend along the first and second side surfaces to engage with the mating connectors to couple the surface assembly to the upper frame. An engagement between the strap connectors and the mating connectors is maintained while permitting a sliding engagement between the upper support surface and the outer ticking as the upper frame articulates between multiple positions.

### CROSS-REFERENCE TO RELATED APPLICATION

This application claims priority to and the benefit under 35 U.S.C. § 119 (e) of U.S. Provisional Application No. 63/591,769, filed on Oct. 20, 2023, entitled “ATTACHMENT SYSTEM FOR PATIENT SUPPORT APPARATUS,” the disclosure of which is hereby incorporated herein by reference in its entirety.

### FIELD OF THE DISCLOSURE

The present disclosure generally relates to a patient support apparatus, and more particularly to an attachment system for coupling a surface assembly to a frame assembly for a patient support apparatus.

### SUMMARY OF THE DISCLOSURE

According to one aspect of the present disclosure, a patient support apparatus includes a frame assembly that includes an upper frame having an upper support surface, a lower surface, and first and second side surfaces extending between the upper support surface and the lower surface. A surface assembly is positioned on the upper support surface. The surface assembly includes an outer ticking, first straps extending from the outer ticking proximate to a head end of the surface assembly, second straps extending from the outer ticking proximate to a foot end of the surface assembly, and a strap connector coupled to a distal end of each of the first and second straps. Mating connectors are coupled to at least one of the upper frame and the outer ticking. The first and second straps are configured to extend along the first and second side surfaces to engage with the mating connectors to couple the surface assembly to the upper frame. An engagement between the strap connectors and the mating connectors is maintained while permitting a sliding engagement between the upper support surface and the outer ticking as the upper frame articulates between multiple positions.

According to another aspect of the present disclosure, a patient support apparatus includes an upper frame defining a first slot and a second slot. The upper frame includes an upper support surface and a lower surface. A surface assembly is positionable on the upper support surface. The surface assembly includes an outer ticking. A first strap extends from the outer ticking. A second strap extends from the outer ticking. The first strap is on an opposing side of a centerline of the surface assembly compared to the second strap. A strap connector is coupled to a distal end of each of the first strap and the second strap. The first strap extends through the first slot to engage a first mating connector and the second strap extends through the second slot to engage a second mating connector to couple the surface assembly to the upper frame.

According to another aspect of the present disclosure, a patient support apparatus includes a frame assembly including a base frame. An upper frame is operably coupled to the base frame. The upper frame includes an upper support surface, a lower surface opposing the upper support surface, and first and second lateral side surfaces extending between the upper support surface and the lower surface. First and second frame connectors are coupled to the lower surface. A surface assembly is positioned on the upper support surface. The surface assembly includes an outer ticking. A first strap is coupled to the outer ticking. A first connector is coupled to a distal end of the first strap. A second strap is coupled to the outer ticking. A second connector is coupled to a distal end of the second strap. The first strap extends from the outer ticking, along the first side surface, and along the lower surface to engage the first frame connector, and the second strap extends from the outer ticking, along the second side surface, and along the lower surface to engage the second frame connector to couple the surface assembly to the upper frame.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a support apparatus with an attachment system, according to the present disclosure;

FIG. 2 is a side perspective view of a support apparatus with an attachment system that includes opposing straps coupled to one another below an upper frame, according to the present disclosure;

FIG. 3 is a schematic diagram of an attachment system with straps extending from a surface assembly, where the straps have connectors that engage one another proximate to a lower surface of a frame, according to the present disclosure;

FIG. 4 is a partially exploded side perspective view of a support apparatus with a surface assembly that includes straps with strap connectors and a frame assembly that includes frame connectors for engaging the strap connectors, according to the present disclosure;

FIG. 5 is a schematic diagram of an attachment system with straps extending from a surface assembly, where the straps have connectors that engage frame connectors on a lower surface of a frame, according to the present disclosure;

FIG. 6 is a schematic diagram of an attachment system with straps extending from a surface assembly, where the straps have connectors that engage frame connectors on side surfaces of a frame, according to the present disclosure;

FIG. 7 is a partially exploded side perspective view of a support apparatus with a surface assembly that includes straps with strap connectors and a frame assembly that includes slots through which the straps extend, according to the present disclosure;

FIG. 8 is a partial schematic diagram of a lower surface of a frame having slots with straps of an attachment system extending along side surfaces of the frame and through the slots, according to the present disclosure;

FIG. 9 is a schematic diagram of an attachment system with straps extending from a surface assembly, where the straps have strap connectors and proximal connectors and where the straps extend through the slots to engage the strap connectors with the proximal connectors, according to the present disclosure;

FIG. 10 is a partial schematic diagram of a lower surface of a frame having slots with straps of an attachment system extending through slots and along side surfaces to engage surface connectors on a surface assembly, according to the present disclosure;

FIG. 11 is a schematic diagram of an attachment system with straps extending from a surface assembly, where the straps extend through the slots and along side surfaces of the frame to engage surface connectors on a bottom surface of the surface assembly, according to the present disclosure;

FIG. 12 is a schematic diagram of an attachment system with straps extending from a surface assembly, where the straps extend through the slots and along side surfaces of the frame to engage surface connectors on side surfaces of the surface assembly, according to the present disclosure;

FIG. 13 is a schematic diagram of an attachment system with straps extending from a surface assembly, where the straps extend along side surfaces of the frame and through the slots to engage surface connectors on a bottom surface of the surface assembly, according to the present disclosure;

FIG. 14 is a partial schematic diagram of a lower surface of a frame having slots with straps of an attachment system extending through slots and along a lower surface to engage one another, according to the present disclosure;

FIG. 15 is a schematic diagram of an attachment system with straps that have connectors, where the straps extend from a surface assembly, through the slots, and along a lower surface of the frame for opposing connectors to engage one another, according to the present disclosure;

FIG. 16 is a partial schematic diagram of an attachment system with a surface assembly having straps operably coupled with retracting assemblies, according to the present disclosure; and

FIG. 17 is a block diagram of a support apparatus with an attachment system, according to the present disclosure.

### DETAILED DESCRIPTION

The present illustrated embodiments reside primarily in combinations of method steps and apparatus components related to an attachment system for a patient support apparatus. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

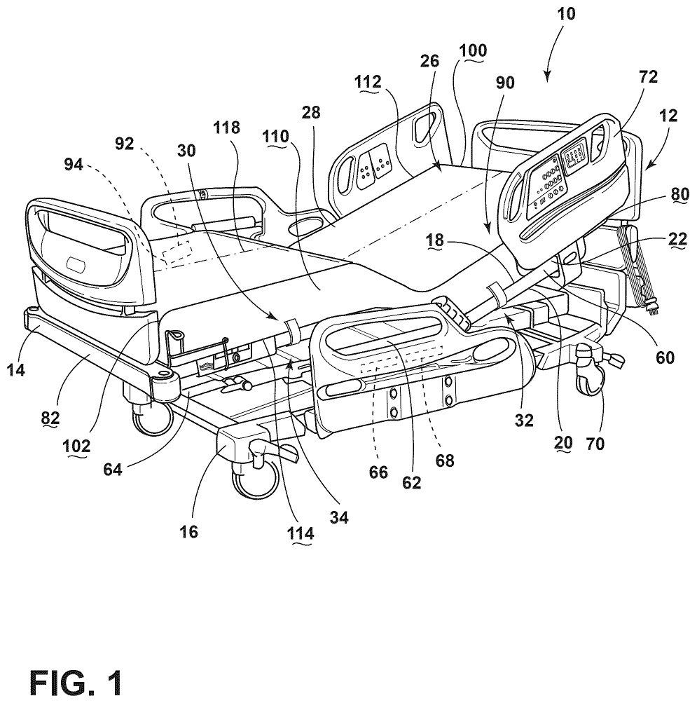

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

With reference to FIGS. 1-17, reference numeral 10 generally designates a patient support apparatus 10 with a frame assembly 12 that includes an upper frame 14 operably coupled to a base frame 16. The upper frame 14 has an upper support surface 18 and a lower surface 20 opposing the upper support surface 18. First and second side surfaces 22, 24 extend between the upper support surface 18 and the lower surface 20. The first and second side surfaces 22, 24 are generally opposing lateral side surfaces of the upper frame 14. A surface assembly 26 is selectively positioned on the upper support surface 18 of the upper frame 14. The surface assembly 26 includes an outer covering or outer ticking 28 with straps 30 coupled to the outer ticking 28. The straps 30 include first straps 32a, 32b (collectively first straps 32) extending from a first side of the outer ticking 28 and second straps 34a, 34b (collectively second straps 34) extending from a second side of the outer ticking 28. The first side opposes the second side.

First strap connectors 40, including first strap connectors 40a, 40b, are coupled to the first straps 32a, 32b, and second strap connectors 42, including second strap connectors 42a, 42b, are coupled to the second straps 34a, 34b. The strap connectors 40, 42 are coupled to distal ends 44 of the first straps 32a, 32b and the second straps 34a, 34b, respectively. Mating connectors 46, 48 are coupled to at least one of the upper frame 14 and the outer ticking 28. The first straps 32a, 32b and the second straps 34a, 34b are configured to extend along the first and second side surfaces 22, 24 of the upper frame 14 and the strap connectors 40, 42 are configured to engage with the mating connectors 46, 48, respectively, to couple the surface assembly 26 to the upper frame 14. Engagements between the strap connectors 40 and the mating connectors 46, 48 are configured to permit a sliding engagement between the upper support surface 18 and the outer ticking 28 as the upper frame 14 articulates between multiple positions.

With reference to FIGS. 1-4, the surface assembly 26 is illustrated with the support apparatus 10 configured as a medical bed. In the example with the medical bed, the support apparatus 10 includes the frame assembly 12 with the base frame 16 coupled to the upper frame 14. The upper frame 14 is adjustable relative to the base frame 16 (e.g., raise, lower, tilt, etc.). Additionally, the upper frame 14 generally includes multiple segments 60, 62, 64 that are independently adjustable relative to one another. These segments 60, 62, 64 generally include a head and chest segment 60, a base or seat segment 62, and a foot segment 64. The segments 60, 62, 64 are configured to move relative to one another, allowing the upper frame 14 to articulate between multiple positions (e.g., an elevated head region or a raised head of bed position, lowered foot region, etc.). The support apparatus 10 includes actuation assemblies 66, 68 for adjusting the upper frame 14 relative to the base frame 16, as well as the segments 60, 62, 64 of the upper frame 14 relative to one another. The base frame 16 includes wheels 70 for moving the medical bed relative to an underlying floor surface. The medical bed also includes siderails 72, which are generally adjustable between a raised position and a lowered position.

The upper frame 14, which may also be referred to as a deck, forms the support surface 18, which selectively supports the surface assembly 26. The lower surface 20 of the upper frame 14 opposes the support surface 18 and is generally oriented toward the base frame 16 and the underlying floor surface. The first and second side surfaces 22, 24 and first and second end surfaces 80, 82 extend between the support surface 18 and the lower surface 20.

The surface assembly 26 is configured to couple or removably attached to the upper frame 14. The support surface 18 may take different shapes based on the movement of the segments 60, 62, 64, which can affect the position of the support surface 18 as described herein. An attachment system 90, which generally includes the straps 30 (i.e., the first straps 32a, 32b and the second straps 34a, 34b), the strap connectors 40, and the mating connectors 46, 48, assists with coupling the surface assembly 26 to the upper frame 14, as well as permitting the predefined sliding movement between the support surface 18 and the upper frame 14 as the upper frame 14 articulates between the multiple positions.

The surface assembly 26 includes the outer ticking 28 defining an interior. The surface assembly 26 may include various components within the interior, such as, but not limited to, a pneumatic system 92, a microclimate management (MCM) layer, a foam support, etc. The straps 30 of the attachment system 90 are coupled to the outer ticking 28. The straps 30 may generally be fixed to the outer ticking. In certain aspects, the first straps 32a, 32b and the second straps 34a, 34b are welded, and more particularly radio frequency (RF) welded to the outer ticking 28. RF welding the first straps 32a, 32b and the second straps 34a, 34b to the outer ticking 28 increases a seam strength between the outer ticking 28 and the first straps 32a, 32b and the second straps 34a, 34b. Welding also results in a flexible attachment that couples the surface assembly 26 to the frame assembly 12 while allowing some movement to reduce bunching as described herein.

Welding also attaches the first straps 32a, 32b and the second straps 34a, 34b to the outer ticking 28 without causing any holes, apertures, or punctures in the outer ticking 28 (e.g., free of apertures through the outer ticking 28 at the seam) that can often be caused with stitched connections, which can allow fluid entry into the mattress. Accordingly, the welded attachments between the first straps 32a, 32b and the second straps 34a, 34b and outer ticking 28 are fluid impermeable, resulting in a self-contained surface assembly 26.

Alternatively, the straps 30 may be sewn to the outer ticking 28. The sewn configuration may increase manufacturing efficiency while providing a connection that allows some movement of the surface assembly 26 to reduce bunching. It is also contemplated that the straps 30 may be movable, such that the connection between the straps 30 and the outer ticking 28 may be semi-permanent or temporary. Surface assemblies 26 used in different areas or units of the medical facility may utilize different connections for the straps 30.

Further, the outer ticking 28 can be moisture impermeable and/or air impermeable. In non-limiting examples, the outer ticking 28 may be constructed of nylon or polyester material with a polyurethane coating that is moisture vapor permeable. This configuration may be advantageous for when the surface assembly 26 has the MCM layer. The MCM layer is generally formed with a spacer material and a blower, which is often included in a control assembly 94 for the MCM layer and the pneumatic system 92. The blower is configured to direct air through the spacer material, which cools the skin of the patient and wicks away moisture.

In additional non-limiting aspects, the outer ticking 28 may be fluid and moisture impermeable, resulting in little or no fluid flowing through the outer ticking 28. The outer ticking 28 and welded straps 30 may then form the self-contained, fluid-resistant surface assembly 26, which may be advantageous in medical settings for reducing fluids, contaminants, etc. from entering the interior of the surface assembly 26.

Referring still to FIGS. 1-4, the surface assembly 26 generally has two first straps 32a, 32b, which may be referred to herein as the first left strap 32a and the first right strap 32b for clarity. The surface assembly 26 also generally has two second straps 34a, 34b, which may be referred to herein as the second left strap 34a and the second right strap 34b for clarity. The first straps 32a, 32b are disposed closer to a head end 100 of the surface assembly 26, and the second straps 34a, 34b are disposed closer to a foot end 102 of the surface assembly 26. The left straps 32a, 34a extend from a first side surface 110, illustrated as the left side surface, of the outer ticking 28, and the right straps 32b, 34b extend from a second side surface 112, illustrated as the right side surface, of the outer ticking 28. It is also contemplated that the straps 30 may extend from a bottom surface 114 of the outer ticking 28, as described further herein, which may be advantageous for allowing bedsheets to be tucked around the surface assembly 26, as well as for using the attachment system 90 with different support apparatuses 10 as described herein.

As illustrated, the first straps 32a, 32b and the second straps 34a, 34b are arranged as mirror images of one another over a centerline 118 of the surface assembly 26. However, one or both of the second straps 34a, 34b may be offset from the first straps 32a, 32b and/or one or both of the left straps 32a, 34a may be offset from the right straps 32b, 34b. The offset configuration(s) may assist with properly aligning the surface assembly 26 on the upper frame 14 (e.g., the head end 100 on the head end segment 60, etc.) and/or with the mating connectors 46, 48 to properly position various components in the surface assembly 26 for treating the patient. The offset configuration(s) may provide an indication to a caregiver of the orientation for the surface assembly 26 relative to the upper frame 14. Other indicators may also be provided, such as differentiating the first straps 32 from the second straps 34, without departing from the teachings herein.

The first straps 32a, 32b and the second straps 34a, 34b may be constructed from an elastic material or a material having elasticity. The elastic material of the straps 30 may allow for more convenient installation of the surface assembly 26 and/or may retain the straps 30 under tension when engaged with the mating connectors 46, 48 to assist in retaining the surface assembly 26 on the upper frame 14. The straps 30 having an elastic quality may be advantageous to allow a tight fit of the straps 30 around the upper frame 14 to reduce or prevent excess strap length between the upper frame 14 and the base frame 16. Further, the elastic straps 30 may hold the surface assembly 26 more securely to the upper frame 14. Moreover, the elastic material of the straps 30 may assist the caregiver with installing the surface assembly 26, allowing the caregiver to pull and extend the straps 30 to engage the mating connectors 46, 48 and allow the straps 30 to return to tension once the engagement is secured.

Additionally or alternatively, the first straps 32a, 32b and the second straps 34a, 34b may be constructed of durable, easy-to-clean materials or fabrics, such as a 210 denier (210D) coated material such as nylon. Further, the first straps 32a, 32b and the second straps 34a, 34b or the left straps 32a, 34a and the right straps 32b, 34b may be constructed of different materials based on the configuration of the attachment system 90.

Referring still to FIGS. 1-4, each strap 30 includes the respective strap connector 40 at the distal end 44 thereof. The strap connectors 40 may be coupled to, integrated into, or embedded in the straps 30. The specific relationship between the straps 30 and the strap connectors 40 may depend on the configuration of the attachment system 90, including the configuration and/or location of the strap connectors 40 and the mating connectors 46, 48.

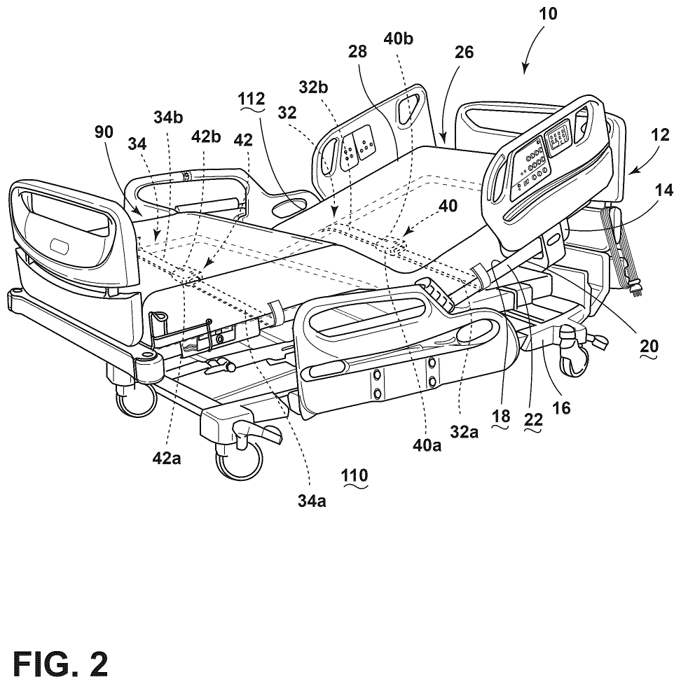

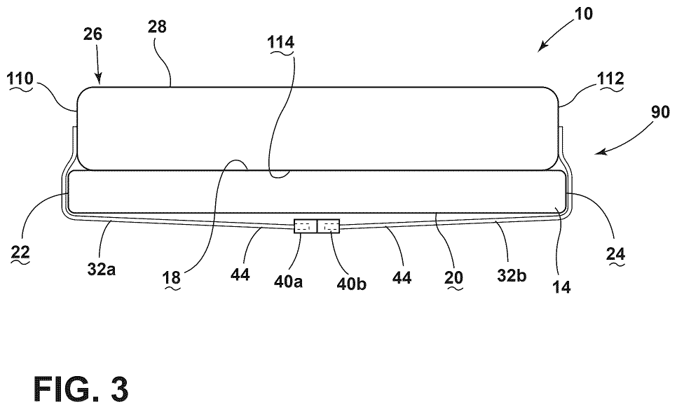

Referring still to FIGS. 2 and 3, in various examples, the strap connectors 40a, 40b on the first straps 32a, 32b, also referred to as the first strap connectors 40a, 40b, are configured to engage or mate with one another, and the strap connectors 42a, 42b on the second straps 34a, 34b, also referred to as the second strap connectors 42a, 42b are configured to engage with one another. In such examples, the mating connectors 46, 48 are configured as the right strap connectors 40b, 42b such that separate mating connectors 46, 48 may be omitted from the attachment system 90. An engagement between the first straps 32a, 32b and an engagement between the second straps 34a, 34b are on an opposing side of the upper frame 14 compared to the outer ticking 28 to couple the surface assembly 26 to the upper frame 14.

Generally, the first strap connectors 40a, 40b are configured to engage one another and the second strap connectors 42a, 42b are configured to engage one another proximate or adjacent to the lower surface 20 of the upper frame 14. For clarity, the strap connectors 40a, 42a on the left straps 32a, 34a may be referred to as left strap connectors 40a, 42a, and the strap connectors 40b, 42b on the right straps 32b, 34b may be referred to as right strap connectors 40b, 42b.

In various examples, the surface assembly 26 is positioned on the support surface 18 of the upper frame 14. The left straps 32a, 34a extend from the outer ticking 28, along the first side surface 22 of the upper frame 14, and along the lower surface 20 of the upper frame 14 toward the second side surface 24. The right straps 32b, 34b extend from the outer ticking 28, along the second side surface 24 of the upper frame 14, and along the lower surface 20 toward the first side surface 22.

In various aspects, the first straps 32a, 32b and the second straps 34a, 34b may be substantially similar lengths. Alternatively, one of the first straps 32a, 32b or the second straps 34a, 34b may be longer to adjust an engagement location between opposing straps 30. This may allow the engagement locations between the first strap connectors 40a, 40b and/or the second strap connectors 42a, 42b to be proximate or adjacent to one of the side surfaces 22, 24, which may be more accessible for a caregiver installing the surface assembly 26.

Moreover, some or all of the strap connectors 40, 42 may be movable along the length of the respective straps 30. This may allow for the adjustment of the engagement location relative to the centerline 118 and/or the lengths of the straps 30. The adjustable length may be advantageous for adjusting the tension of the straps 32, 34 around the upper frame 14 for better securing the surface assembly 26. Additionally or alternatively, one or both of the first straps 32a, 32b and one or both of the second straps 34a, 34b may have multiple strap connectors 40 arranged along the length of the straps 30. This configuration may allow for different engagement locations of the mating strap connectors 40. This may be advantageous for using the surface assembly 26 with different support apparatuses 10.

Referring still to FIGS. 2 and 3, in various non-limiting examples, the left strap connectors 40a, 42a are magnets, and the right strap connectors 40b, 42b are mating magnets. In such examples, the magnets engage one another, adjacent to the lower surface 20 of the upper frame 14. The magnets and the mating magnets may be permanent magnets of opposite polarity. In additional non-limiting examples, the left strap connectors 40a, 42a are magnets, and the right strap connectors 40b, 42b are metal or metallic components that are magnetically attracted to the magnets to operably couple the first straps 32a, 32b with the second straps 34a, 34b. It is also contemplated that the left strap connectors 40a, 42a are the metal or metallic components, while the right strap connectors 40b, 42b are the magnets.

Further, the left strap connectors 40a, 42a and/or the right strap connectors 40b, 42b may be electromagnets. It is contemplated that both the first straps 32a, 32b and the second straps 34a, 34b include electromagnets, the first straps 32a, 32b include electromagnets while the second straps 34a, 34b include a permanent magnet or a metal component, or the second straps 34a, 34b include electromagnets while the first straps 32a, 32b include a permanent magnet or a metal component.

Additionally or alternatively, the first strap connectors 40a, 40b and the second strap connectors 42a, 42b may be mating hook-and-loop fasteners. In an illustrative example, the left straps 32a, 34a include the hook fasteners, and the right straps 32b, 34b include the loop fasteners. The hook-and-loop fasteners may be disposed at the distal ends 44 of the first straps 32a, 32b and the second straps 34a, 34b, arranged in sections at intervals along the lengths of the first straps 32a, 32b and the second straps 34a, 34b, and/or extend a substantial or the entire length of the first straps 32a, 32b and the second straps 34a, 34b. In further non-limiting examples, the first and second strap connectors 42a, 42b may be buckles, cinching assemblies, seatbelt-style connectors, clips, snap features, hook-and-eye connectors, etc.

The surface assembly 26 includes the straps 30 with the left connectors 40a, 42a configured to engage the right connectors 40b, 42b around the upper frame 14. Accordingly, the straps 30 couple the surface assembly 26 to the frame assembly 12. Further, the surface assembly 26 may be coupled to multiple types and configurations of frame assemblies 12 as the surface assembly 26 does not utilize specific components of the frame assembly 12 to couple to the upper frame 14. The straps 30 may extend from the side surfaces 110, 112 of the outer ticking 28, which may include the bend or seam between the side surfaces 110, 112 and the bottom surface 114, to extend along the side surfaces 22, 24 of the upper frame 14.

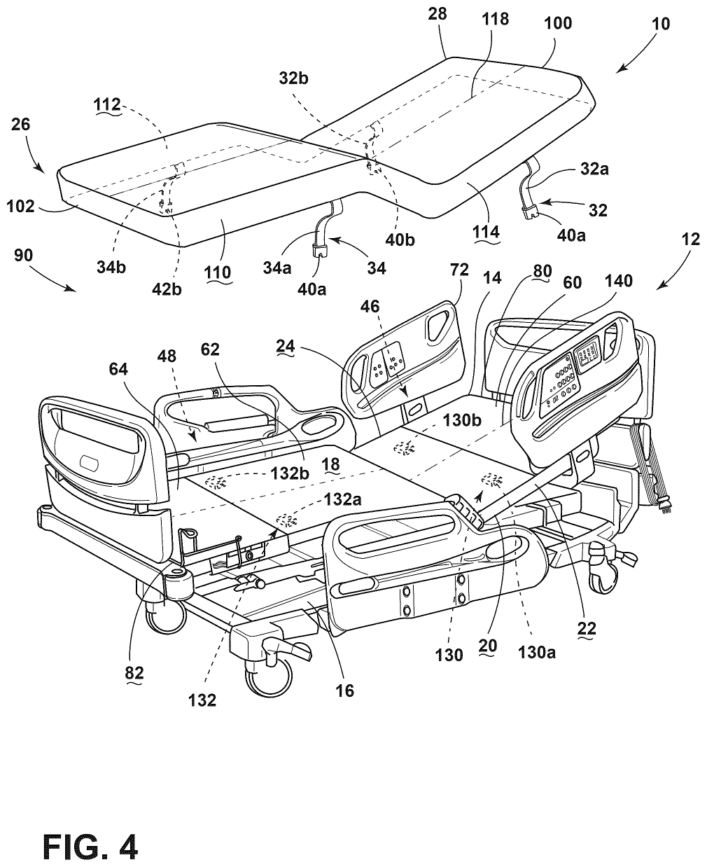

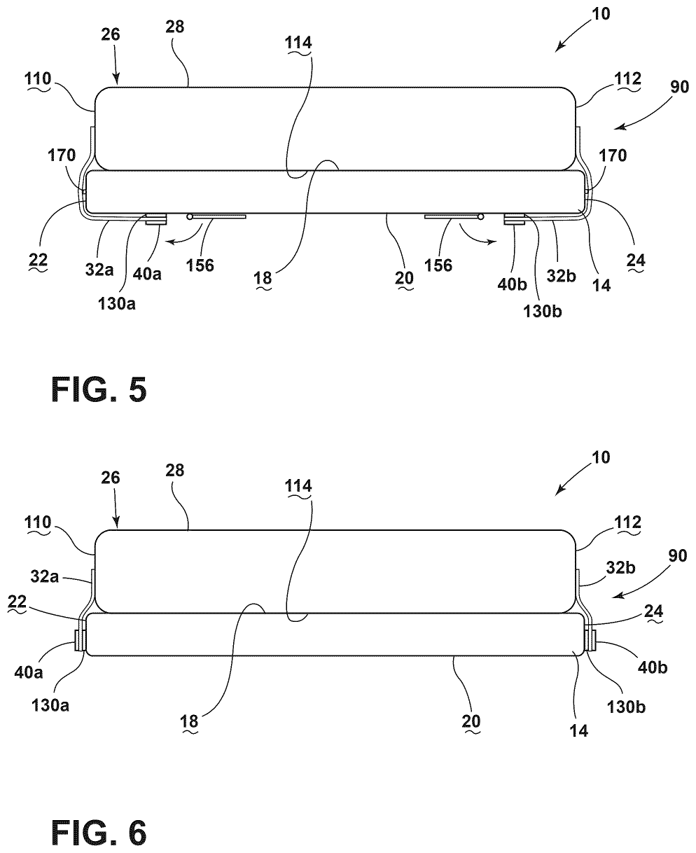

Referring again to FIG. 4, and also to FIGS. 5 and 6, in various examples, the attachment system 90 includes the mating connectors 46, 48 configured as frame connectors 130, 132 that may be coupled to or integrated with the frame assembly 12. Generally, the frame connectors 130 include frame connectors 130a, 130b, and the frame connectors 132 include frame connectors 132a, 132b. The frame connectors 130, 132 are coupled to an outer surface of the upper frame 14 or may be incorporated or integrated into the upper frame 14 during the manufacturing process. The frame connectors 130, 132 are arranged on the upper frame 14 to mate with the strap connectors 40, 42, respectively. The first and second strap connectors 40, 42 are configured to engage corresponding frame connectors 130, 132.

The frame connectors 130, 132 are positioned to engage the strap connectors 40, 42. The straps 30 may have different lengths or the strap connectors 40, 42 may have different adjustability to engage the frame connectors 130, 132. Generally, the attachment system 90 includes two first frame connectors 130a, 130b on the head and chest segment 60, and two second frame connectors 132a, 132b on the foot segment 64. One of each of the first and second frame connectors 130, 132, referred to as first and second left frame connectors 130a, 132a for clarity, are arranged on a first side of a centerline 140 of the upper frame 14 (e.g., illustrated as a left side), and the other of the first and second frame connectors 130b, 132b, referred to as first and second right frame connectors 130b, 132b for clarity, are arranged on a second side of the centerline 140 of the upper frame 14 (e.g., illustrated as a right side).

The left frame connectors 130a, 132a are generally arranged as mirror images of the right frame connectors 130b, 132b. However, one or both of the left frame connectors 130a, 132a may be offset from the right frame connectors 130b, 132b based on the arrangement of the straps 30. This may assist with properly positioning the surface assembly 26 on the upper frame 14. Further, the frame connectors 130, 132 on the head end segment 60 and the foot end segment 64 assist with coupling the surface assembly 26 proximate to both the head end 100 and the foot end 102, which can reduce or prevent twisting or sliding of the ends 100, 102 of the surface assembly 26 relative to the upper frame 14 that can be caused by the caregiver, patient, etc.

With reference still to FIGS. 4-6, the frame connectors 130, 132 may be arranged at different locations, such as proximate to the centerline 140, at a more central location between the centerline 118 and the side surfaces 22, 24, or proximate to the side surfaces 22, 24. In certain aspects, the frame connectors 130, 132 are arranged adjacent to or on the opposing side surfaces 22, 24 of the upper frame 14. For example, the frame connectors 130, 132 may be coupled to the lower surface 20 less than about 10 inches from the side surfaces 22, 24, respectively. The positioning of the frame connectors 130, 132 adjacent to the side surfaces 22, 24 or on the side surfaces 22, 24 may allow for easier access by the caregiver, more convenient engagement of the strap connectors 40, 42 to the frame connectors 130, 132, and reduced interference of the straps 30 with the operation of the frame assembly 12. Additionally, the frame connectors 130, 132 on or adjacent to the side surfaces 22, 24 may assist with providing visible feedback to the caregiver that the surface assembly 26 has been properly installed (i.e., with the strap connectors 40, 42 engaging the frame connectors 130, 132) on the frame assembly 12.

The straps 30 are illustrated extending from the side surfaces 110, 112 of the outer ticking 28. It is also contemplated that the straps 30 may extend from the bottom surface 114 of the outer ticking 28, as described further herein. In such examples, the straps 30 may extend from the bottom surface 114 of the outer ticking 28, along the support surface 18, around the side surfaces 22, 24, and along the lower surface 20 to engage the mating frame connectors 130, 132. This configuration may be advantageous for allowing bedsheets to be tucked around the surface assembly 26, as well as for using the attachment system 90 with different support apparatuses 10 as described herein.

In various aspects, as illustrated in FIGS. 4 and 5, the frame connectors 130, 132 are coupled to the lower surface 20 of the upper frame 14. This may be advantageous for concealing the engagement location between the strap connectors 40 and the frame connectors 130, 132, as well as moving the engagement location to an area that is generally not accessed by the patient. In such examples, the left straps 32a, 34a extend from the first side surface 110 of the outer ticking 28, along the first side surface 22 of the upper frame 14, and along the lower surface 20 of the upper frame 14 to engage the left frame connectors 130a, 132a. Similarly, the right straps 32b, 34b extend from the second side surface 112 of the outer ticking 28, along the second side surface 24 of the upper frame 14, and along the lower surface 20 of the upper frame 14 to engage the right frame connectors 130b, 132b.

As illustrated in FIG. 6, in non-limiting aspects, the frame connectors 130, 132 are coupled to the side surfaces 22, 24 of the upper frame 14. In such examples, the straps 30 may have a shorter length or may be biased or retracted to a shorter length compared to when the frame connectors 130, 132 are on the lower surface 20 (FIGS. 4 and 5) or when the strap connectors 40, 42 engage one another (FIGS. 2 and 3). Further, moving the frame connectors 130, 132 to the side surfaces 22, 24 may be advantageous for providing increased visibility of the engagement location to the caregiver for engaging the strap connectors 40, 42 with the frame connectors 130, 132 and confirming proper installation of the surface assembly 26.

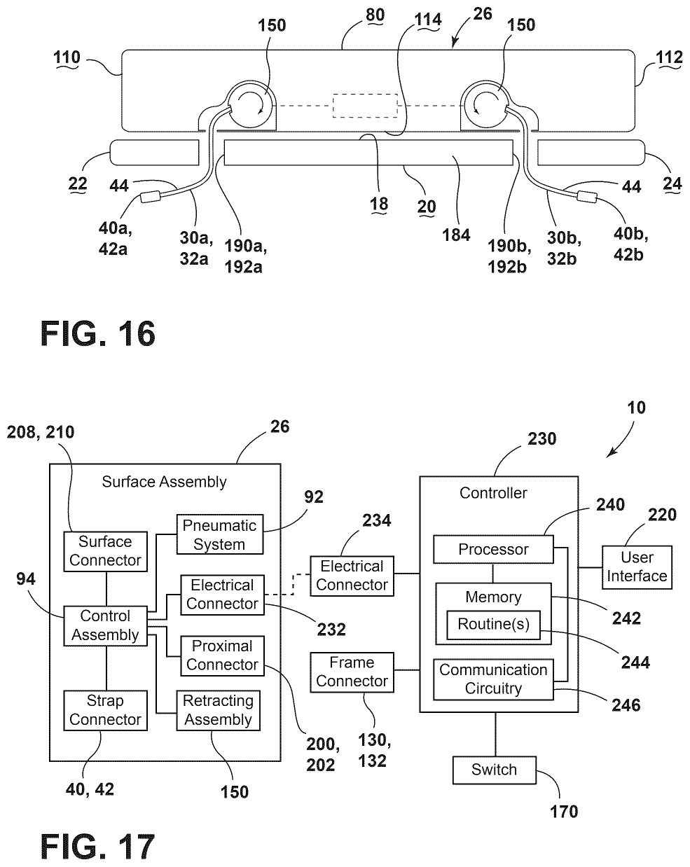

The strap connectors 40, 42 and the frame connectors 130, 132 may have similar configurations as those described with respect to FIGS. 2 and 3. The strap connectors 40, 42 may be movable along the length of the respective straps 30. Additionally or alternatively, one or both of the first straps 32a, 32b and the second straps 34a, 34b may have multiple strap connectors 40, 42 arranged along the length of the straps 30. This may allow for the adjustment of the straps 30 for different locations of frame connectors 130, 132, such as on different frame assemblies 12. Further, the straps 30 may be operably coupled with retracting assemblies 150 (FIG. 16) as described herein.

Referring still to FIGS. 4-6, in certain aspects, the strap connectors 40, 42 and the frame connectors 130, 132 may be hook-and-loop fasteners. In such examples, the surface assembly 26 is positioned on the upper frame 14 with the straps 30 extending along the respective side surfaces 22, 24 of the upper frame 14. The caregiver may then engage the strap connectors 40, 42 with the frame connectors 130, 132 on the side surfaces 22, 24 or the lower surface 20. The hook-and-loop fasteners may be disposed at the distal ends 44 of the first straps 32a, 32b and the second straps 34a, 34b, arranged in sections at intervals along the lengths of the first straps 32a, 32b and the second straps 34a, 34b, and/or extend a substantial or the entire length of the first straps 32a, 32b and the second straps 34a, 34b. In additional non-limiting examples, the first and second strap connectors 42a, 42b may be buckles, cinching assemblies, seatbelt-style connectors, clips, snap features, hook-and-eye connectors, etc.

Moreover, the strap connectors 40, 42 and the frame connectors 130, 132 may be permanent magnets of opposite polarity or a combination of permanent magnets and metal components that are magnetically attracted to the magnets. In examples where the frame connectors 130, 132 and the strap connectors 40, 42 are both magnets or where one of the frame connectors 130, 132 and the strap connectors 40, 42 are magnets, magnetic fields of the magnets may be sufficient for automatic installation of the surface assembly 26.

In an illustrative, non-limiting example, the frame connectors 130, 132 are permanent magnets with magnetic fields that can extend up to or proximate to the side surfaces 22, 24 of the upper frame 14 to attract components, such as the strap connectors 40, 42. Stated differently, the magnetic fields for the frame connectors 130, 132 can magnetically attract components extending adjacent to or along the side surfaces 22, 24 of the upper frame 14. In this way, when the caregiver positions the surface assembly 26 on the upper frame 14 with the straps 30 extending downward, along or proximate to the side surfaces 22, 24 of the upper frame 14, the strap connectors 40, 42 can be affected by the magnetic field of the frame connectors 130, 132 to be drawn toward and to the frame connectors 130, 132. The frame connectors 130, 132, with this stronger magnetic field, may cause automatic engagement with the strap connectors 40, 42 and, consequently, automatic installation of the surface assembly 26 after the surface assembly 26 is positioned on the support surface 18.

Referring still to FIGS. 4-6, in this manner, positioning the surface assembly 26 on the support surface 18 with the straps 30 hanging downward (e.g., not caught under the surface assembly 26) brings the strap connectors 40, 42 into a range of the magnetic fields of the frame connectors 130, 132 to allow the strap connectors 40 to move toward and ultimately engage the frame connectors 130, 132 without the caregiver actively or manually moving the straps 30. This may be advantageous for more efficient and convenient installation of the surface assembly 26 on the frame assembly 12. The frame connectors 130, 132 with this magnetic field may be on the side surfaces 22, 24 or on the lower surface 20. It is also contemplated that the magnets that have the attracting magnetic field for automatic installation may be on the straps 30 without departing from the teachings herein.

In examples where the frame connectors 130, 132 are magnets, covers 156 may be included in the attachment system 90. Generally, the attachment system 90 may have one cover 156 per magnet, but other configurations are contemplated. The cover 156 may be operably coupled to the frame assembly 12 to extend over the magnets and provide a barrier over and/or around the magnetic frame connectors 130, 132. This barrier may reduce or prevent the magnetic field from reaching beyond the cover 156, reducing or preventing any potential interference with other objects in the medical facility or hospital room. Generally, the covers 156 are constructed of metal materials.

For example, certain machines or devices are affected by magnetic fields. When using such machines or devices, the cover 156 can be moved over the frame connectors 130, 132 to block the magnetic fields, thereby reducing or preventing any effect on the operation of the machine or the device. The cover 156 may be pivotable, hinged, rotatable, slidable, snap-engaging, hooked, or otherwise coupled to the frame assembly 12 in a manner that allows the cover 156 to move between a covered position over frame connectors 130, 132 and an uncovered position.

In examples where both the strap connectors 40, 42 and the frame connectors 130, 132 are magnets or where the engagement between the strap connectors 40, 42 and the frame connectors 130, 132 is to be maintained, the covers 156 may be configured to extend over both the strap connectors 40, 42 and the frame connectors 130, 132 when the strap connectors 40, 42 are engaged with the frame connectors 130, 132. Accordingly, the covers 156 may be shaped to fit over both connectors 40, 42, 130, 132, while providing a barrier over and around the engaged connectors 40, 42, 130, 132. This configuration may be advantageous for maintaining the engagement between the straps 30 and the upper frame 14, while also utilizing components that may be affected by magnetic fields.

In further, non-limiting examples, at least one of the strap connectors 40, 42 and the frame connectors 130, 132 may be electromagnets. The electromagnets may be operably coupled with one or more activation switches 170 for adjusting the electromagnets between activated states, emitting a magnetic field, and deactivated states. As an illustrative example, the frame connectors 130, 132 may be configured as the electromagnets and the strap connectors 40, 42 may be permanent magnets or metal components magnetically attracted to the electromagnets when the electromagnets are activated. In examples with the electromagnets, the attachment system 90 may also include the cover 156 to allow the electromagnets to be active and engage the strap connectors 40, 42 and reduce the effect the magnetic field has on other devices or machines.

Further, it is also contemplated that the strap connectors 40, 42 may engage the mating connectors 46, 48 on the upper support surface 18. In such examples, the frame connectors 130, 132 may be coupled to the support surface 18, generally adjacent to the side surfaces 22, 24 of the upper frame 14. The straps 30 may extend from the bottom surface 114 or the side surfaces 110, 112. The straps 30 extend between the bottom surface 114 and the support surface 18 to engage the frame connectors 130, 132.

Referring still to FIGS. 4-6, the surface assembly 26 includes the straps 30 with the left strap connectors 40a, 42a that engage the left frame connectors 130a, 132a and the right connectors 40b, 42b configured to engage the right frame connectors 130b, 132b. The surface assembly 26 is coupled to the frame assembly 12 by the engagement between the strap connectors 40, 42 and the frame connectors 130, 132. The straps 30 may be elastic or associated with the retracting assemblies 150 to adjust the straps 30 to different or alternate locations of frame connectors 130, 132. The surface assembly 26 may be coupled to multiple types and configurations of frame assemblies 12.

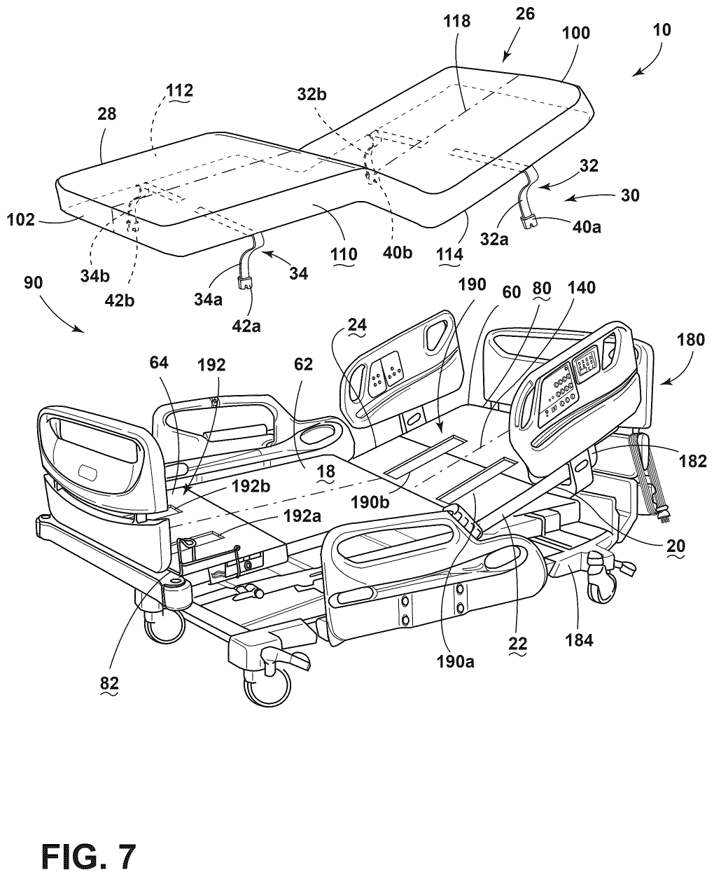

With reference to FIGS. 7-16, in various aspects, the support apparatus 10 includes a frame assembly 180 having a base frame 182 and an upper frame 184 with features to assist in retaining the engagement with the surface assembly 26. The frame assembly 180 is generally constructed and operates similarly to the frame assembly 12 in FIGS. 2-6 with the difference being slots 190, 192 defined in the upper frame 14. Generally, the slots 190, 192 extend from the support surface 18 and through the lower surface 20 (e.g., through the upper frame 184). The size and orientation of the slots 190, 192 can be optimized to allow for the movement of certain parts of the surface assembly 26 with different frame assemblies 12, 180. For example, the slots 190, 192 may extend between the opposing end surfaces 80, 82 and/or the opposing side surfaces 22, 24, which can still allow for the sliding engagement between the surface assembly 26 and the frame assembly 180.

Similar to the arrangement of the frame connectors 130, 132 illustrated in FIGS. 4-6, the upper frame 184 illustrated in FIGS. 7-16 includes two first slots 190a, 190b on the head and chest segment 60, and two second slots 192a, 192b on the foot segment 64. One of each of the first and second slots 190, 192, referred to as first and second left slots 190a, 192a for clarity, are arranged on the first side of the centerline 140 of the upper frame 184 (e.g., illustrated as a left side), and the other of the first and second slots 190b, 192b, referred to as first and second right slots 190b, 192b for clarity, are arranged on the second side of the centerline 140 of the upper frame 184 (e.g., illustrated as a right side).

The left slots 190a, 192a are generally arranged as mirror images of the right slots 190b, 192b. However, one or both of the left slots 190a, 192a may be offset from the right slots 190b, 192b based on the arrangement of the straps 30. This may assist with properly positioning the surface assembly 26 on the upper frame 184. Further, the slots 190, 192 on the head end segment 60 and the foot end segment 64 assist with coupling the surface assembly 26 proximate to both the head end 100 and the foot end 102, which can reduce or prevent twisting or sliding of the ends 100, 102 of the surface assembly 26 relative to the upper frame 14 that can result in misalignment.

The slots 190, 192 generally extend between the end surfaces 80, 82, parallel with the centerline 140 of the upper frame 184. The length of the slots 190, 192 between the head end surface 80 and the foot end surface 82 allows for the predefined sliding movement of the surface assembly 26 relative to the support surface 18 while maintaining the overall proper positioning of the surface assembly 26 as described herein.

The surface assembly 26 includes the straps 30 extending from the opposing side surfaces 110, 112 or the bottom surface 114 of the outer ticking 28, which extend through the respective slots 190, 192 and engage the mating connectors 46, 48. Typically, the first left strap 32a extends through the first left slot 190a, the first right strap 32b extends through the first right slot 190b, the second left strap 34a extends through the second left slot 192a, and the second right strap 34b extends through the second right slot 192b. The engagement between the straps 30 and the outer ticking 28, as well as the straps 30 and the upper frame 184 may be different based on the mating connectors 46, 48 and the straps 30. The straps 30 wrap around the side surfaces 22, 24 and through the upper frame 184 to engage the mating connectors 46, 48 (e.g., in a “backpack” style configuration).

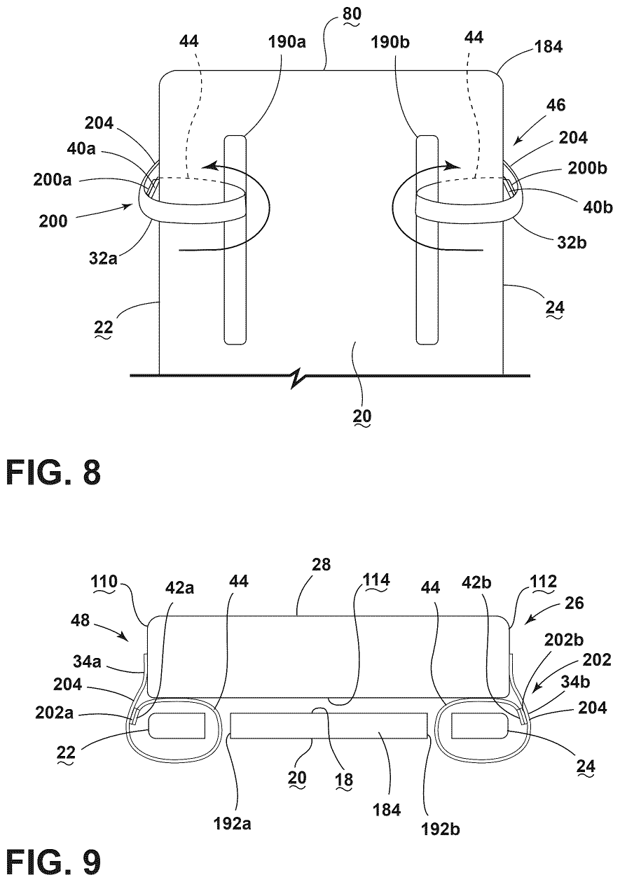

With reference still to FIGS. 8 and 9, the straps 30 include the strap connectors 40, 42 at the distal ends 44 thereof, and the attachment system 90 also includes the mating connectors 46, 48 configured as proximal connectors 200, 202 at proximal portions 204 of the straps 30 closer to the seam with the outer ticking 28 (e.g., both the strap connectors 40, 42 and the mating connectors 46, 48 are disposed on the straps 30). Accordingly, the first left strap 32a includes the first left strap connector 40a and a first left proximal connector 200a, and the first right strap 32b includes the first right strap connector 40b and a first right proximal connector 200b. Similarly, the second left strap 34a includes the second left strap connector 42a and a second left proximal connector 202a, and the second right strap 34b includes the second right strap connector 42b and a second right proximal connector 202b.

The straps 30 extend from the side surfaces 110, 112 of the outer ticking 28 and along the side surfaces 22, 24 of the upper frame 184. The straps 30 then extend along the lower surface 20 of the upper frame 184 and through the respective slots 190, 192 to loop and engage the proximal connectors 200, 202, respectively. Accordingly, the straps 30 loop around the side surfaces 22, 24 of the upper frame 184, along the lower surface 20, through the slots 190, 192, and along the upper surface 18 of the upper from 184 to engage themselves proximate to the side surfaces 22, 24 to couple the surface assembly 26 to the upper frame 184. The straps 30 may also extend from the bottom surface 114 of the outer ticking 28. In such examples, the straps 30 extend through the slots 190, 192, along the side surfaces 22, 24, and along the upper surface 18 to engage the proximal connectors 200, 202. The straps 30 may extend from the bottom surface 114 proximate to the side surfaces 22, 24 for more convenient engagement between the strap connectors 40, 42 and the proximal connectors 200, 202.

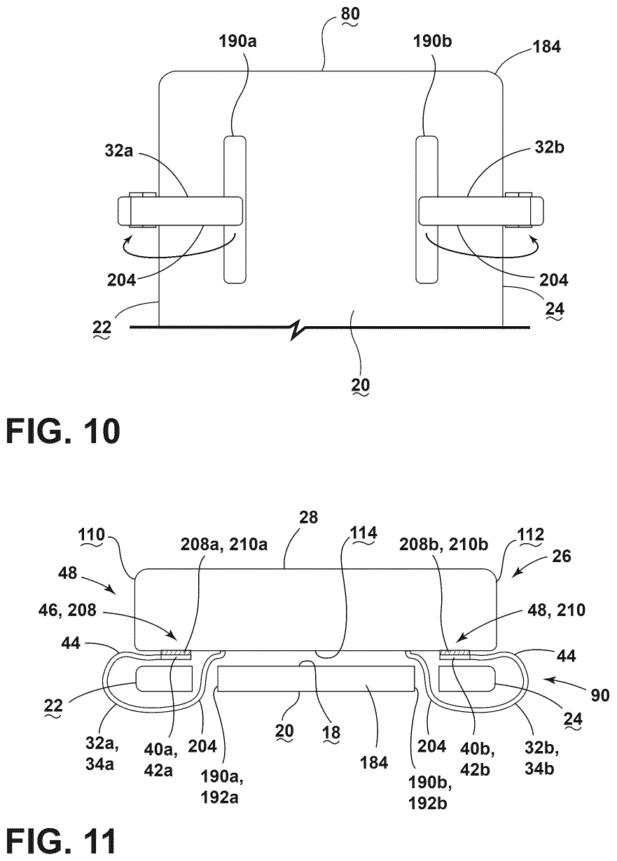

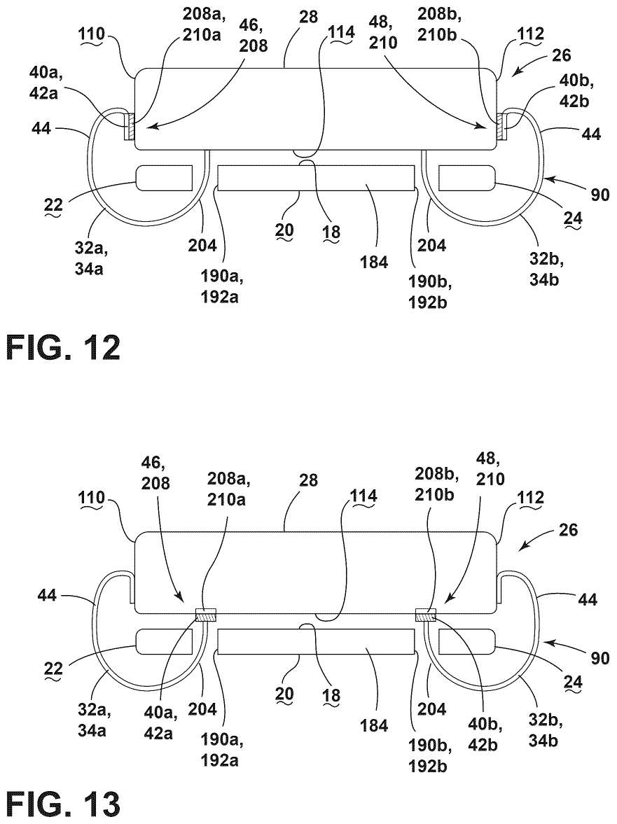

As illustrated in FIGS. 10-13, the attachment system 90 includes the strap connectors 40, 42 at the distal ends 44 of the straps 30, and also includes the mating connectors 46, 48 configured as surface connectors 208, 210. The surface connectors 208, 210 are coupled to or integrated into the outer ticking 28, such as the side surfaces 110, 112 (FIG. 12) or the bottom surface 114 (FIGS. 11 and 13) of the outer ticking 28. The bottom surface 114 is the surface that abuts and rests on the support surface 18 of the upper frame 184. The surface connectors 208, 210 are generally aligned or correspond with the slots 190, 192 but may be slightly offset from the slots 190, 192 without departing from the teachings herein. Accordingly, a first left surface connector 208a is aligned with the first left slot 190a, a first right surface connector 208b is aligned with the first right slot 190b, a second left surface connector 210a is aligned with the second left slot 192a, and a second right surface connector 210b is aligned with the second right slot 192b.

The straps 30 may extend from the bottom surface 114 of the outer ticking 28 rather than the side surfaces 110, 112. In such examples, the positioning of the straps 30 on the bottom surface 114 generally aligns with the slots 190, 192. The straps 30 may be directly in-line with the slots 190, 192 or may be slightly offset from the slots 190, 192 to minimize the distance the straps 30 extend along the support surface 18 and below the surface assembly 26.

As illustrated in FIG. 11, the straps 30 extend downward from the bottom surface 114, through the slots 190, 192, along the lower surface 20, along the outer side surfaces 22, 24, and engage the surface connectors 208, 210, which are illustrated on the bottom surface 114. In this way, the straps 30 extend from the bottom surface 114, loop around the side surfaces 22, 24 of the upper frame 184, and engage the surface connectors 208, 210 on the bottom surface 114 proximate to where the straps 30 extend from the bottom surface 114. This configuration may be advantageous for tucking bedsheets around the surface assembly 26 without the attachment system 90 impinging on the bedsheet. Moreover, the caregiver can easily and conveniently see that the surface assembly 26 is correctly installed on the upper frame 184.

As illustrated in FIG. 12, the surface connectors 208, 210 may be coupled to the side surfaces 110, 112 of the outer ticking 28, respectively. In such examples, the straps 30 extend from the bottom surface 114, through the slots 190, 192, around the outer side surfaces 22, 24 of the upper frame 184, and to the side surfaces 110, 112 to engage the surface connectors 208, 210. This configuration may be advantageous for ease and convenience of coupling the connectors 40, 42, 208, 210 and for visibility of the coupling location for the caregiver. The caregiver can easily and conveniently view that the surface assembly 26 is correctly installed with the engagement location on the side surfaces 110, 112 of the outer ticking 28.

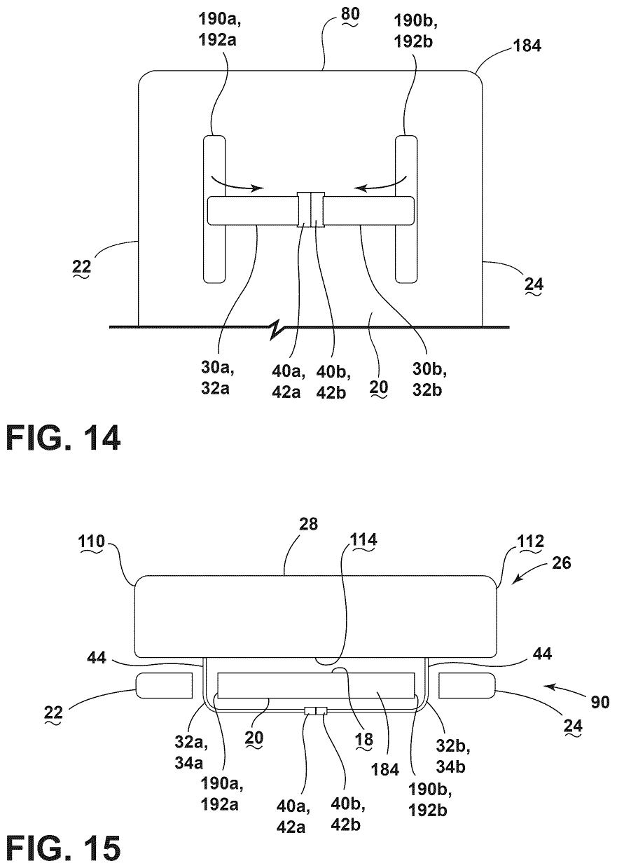

As illustrated in FIG. 14, the surface connectors 208, 210 are generally vertically aligned with the slots 190, 192 with the straps 30 extending from the side surfaces 110, 112 of the outer ticking 28. When the surface assembly 26 is positioned on the upper frame 184, the surface connectors 208, 210 are arranged over the respective slots 190, 192 to be accessed from below the upper frame 184. In this way, the caregiver may wrap the straps 30 around the side surfaces 22, 24 of the upper frame 184 and insert the distal ends 44 of the straps 30 through the slots 190, 192 to engage the bottom surface connectors 208, 210, respectively. The frame connectors 130, 132 may extend a substantial or entire length of the slots 190, 192 for more convenient and efficient engagement between the frame connectors 130, 132 and the strap connectors 40, 42 by the caregiver, which may be advantageous with less visibility below the upper frame 184.

Referring to FIGS. 14 and 15, in certain aspects, the strap connectors 40, 42 engage one another, similar to the configuration in FIG. 3. In such examples, the first strap connectors 40a, 40b and the second strap connectors 42a, 42b (e.g., the mating connectors 46, 48) may be mating features that couple and engage with one another. In such examples, the straps 30 extend from the bottom surface 114 of the outer ticking 28 and through the respective slots 190, 192. Instead of extending outward, the straps 30 extend inward toward one another to engage the opposing respective strap connectors 40, 42.

Referring again to FIGS. 7-15, the strap connectors 40, 42 and the mating connectors 46, 48 (e.g., the opposing strap connector 40, 42, the proximal connectors 200, 202, and/or the surface connectors 208, 210) may have similar configurations as described herein with respect to FIGS. 2 and 3 and FIGS. 4-6. Accordingly, the strap connectors 40, 42, the proximal connectors 200, 202, and the surface connectors 208, 210 may be configured as one or more of permanent magnets, metal features, electromagnets, hook-and-loop fasteners, buckles, cinching assemblies, seatbelt-style connectors, clips, snap features, hook-and-eye connectors, etc.

Referring still to FIGS. 7-15, the slots 190, 192 in the upper frame 184 may be advantageous for coupling the surface assembly 26 to the upper frame 14 and for allowing the predefined sliding engagement therebetween. Moreover, the straps 30 extending through the slots 190, 192 may be advantageous for retaining the surface assembly 26 on the frame assembly 180 when inadvertent or accidental disengagement between the connectors occurs. The engagement through the slots 190, 192 provides an additional engagement location for the surface assembly 26 to the frame assembly 180. The surface assembly 26 can be interchanged between the support apparatus 10 with the upper frame 14 without the slots 190, 192 (e.g., with the strap connectors 40, 42 engaging each other or the frame connectors 130,132) and the upper frame 184 with the slots 190, 192 (e.g., with the strap connectors 40, 42 engaging each other, the proximal connectors 200, 202, or the surface connectors 208, 210). It is also contemplated that the upper frame 184 with the slots 190, 192 may also include the frame connectors 130, 132 without departing from the teachings herein.

Referring again to FIGS. 4-6, and still to FIGS. 7-15, it is also contemplated that the attachment system 90 may utilize the surface connectors 208, 210 and the frame connectors 130, 132 together. In such examples, the strap connectors 40, 42 may engage either of the surface connectors 208, 210 or the frame connectors 130, 132. Additionally or alternatively, the surface connectors 208, 210 may engage the frame connectors 130, 132 to couple the surface assembly 26 to the frame assembly 12, 180. In such examples, the attachment system 90 may utilize the surface connectors 208, 210 on the outer ticking 28 to engage frame connectors 130, 132 on the upper support surface 18. The attachment system 90 may utilize the engagement between the surface connectors 208, 210 and the frame connectors 130, 132 as well as the strap connectors 40, 42 with the mating connectors 46, 48 to provide two engagements for coupling the surface assembly 26 to the upper frame 14, 184.

Referring again to FIG. 16, as well as to FIGS. 1-15, the attachment system 90 may also include the retracting assembly 150 or multiple retracting assemblies 150 with one retracting assembly 150 for each of the first straps 32a, 32b and the second straps 34a, 34b, respectively. The retracting assemblies 150 allow for adjustment of the lengths of the first straps 32a, 32b and the second straps 34a, 34b. Generally, each retracting assembly 150 may have a ratchet, that allows the respective strap 30 to be pulled and lengthened from the retracting assembly 150 and retained at the increased length. The retracting assembly 150 may also include a spring or other biasing member, such that when the straps 30 are again pulled, the ratchet is released and the spring retracts or shortens the straps 30, drawing the straps 30 into the retracting assemblies 150.

When the attachment system 90 includes the retracting assemblies 150, the straps 30 may have an increased thickness at the distal ends 44 to support the pulling motion for adjusting the length of the straps 30. The retracting assembly 150 may be disposed within the interior of the outer ticking 28 or may be coupled to an outer surface of the outer ticking 28. The retracting assemblies 150 may be advantageous to place the straps 30 under tension to retain the surface assembly 26 in position and reduce the excess length of the straps 30 that may cause interference for the frame assembly 12, 180 or the caregiver. Allowing the lengths of the straps 30 to adjust may also help the caregiver install the surface assembly 26 and then retract the excess length of the straps 30 to secure the surface assembly 26 to the frame assembly 12, 180. The retracting assemblies 150 with the straps 30 may be removably coupled with the surface assembly 26, such as, for example, on the side surfaces 110, 112 of the outer ticking 28. This may allow the attachment system 90 to be added to a surface/mattress that would otherwise not include the straps 30.

When using the retracting assemblies 150, the straps 30 are configured to retract into the surface assembly 26 or housings for the retracting assemblies 150. The retracted straps 30 may aid in efficiently and conveniently transporting the surface assembly 26 separate from the frame assembly 12, 180, as well as more conveniently storing the surface assembly 26. The retracting assemblies 150 may be used with any configuration of the attachment system 90 and/or the support apparatus 10.

Further, reference still to FIGS. 1-16, in examples where one or both of the strap connectors 40, 42 and the mating connectors 46, 48 (e.g., the other of the strap connectors 40, 42, the frame connectors 130, 132, the proximal connectors 200, 202, and/or the surface connectors 208, 210) are electromagnets, the electromagnets may be activated and deactivated by the caregiver via the activation switch or switches 170. The activation switches 170 may be on the frame assembly 12, 180, and may be a button, dial, switch, or other feature the caregiver may interact with to adjust the electromagnet. In such examples, the caregiver may position the surface assembly 26 on the upper frame 14, 184 and toggle the electromagnets to the active state via the switch or switches 170 to engage the mating connectors 46, 48. The magnetic fields of the electromagnets may be of sufficient strength to automatically install the surface assembly 26 as described herein. The frame assembly 12, 180 may have a single activation switch 170 for the electromagnets or may have multiple activation switches 170 without departing from the teachings herein.

Referring to FIG. 17, the electromagnets may also be controlled automatically or through a user interface 220 of the support apparatus 10 when the surface assembly 26 is electrically coupled with the frame assembly 12, 180. The installation of the surface assembly 26 to the frame assembly 12, 180 may include providing electrical communication or electrical coupling of the surface assembly 26 to the frame assembly 12, 180. For example, in various aspects, the surface assembly 26 may include electronically controlled components, such as the retracting assemblies 150, the pneumatic system 92, and/or the MCM layer, which can be a controller 230 via the control assembly 94 of the surface assembly 26. The pneumatic system 92 generally includes the blower and bladders for providing various therapies or assistance to the caregiver, such as turn bladders, alternating pressure bladders, percussion and vibration bladders, etc.

In such examples, the electronically controlled components may be communicatively coupled with the controller 230 of the support apparatus 10. A first electrical connector 232 of the surface assembly 26 is engaged with a mating electrical connector 234 of the support apparatus 10 to provide electrical communication therebetween. Generally, the communication between the surface assembly 26 and the frame assembly 12, 180 is a wired communication. However, the communication may be wireless without departing from the teachings herein.

When the communication is established between the surface assembly 26 and the frame assembly 12, 180, the controller 230 of the support apparatus 10 may activate the electromagnets to couple the surface connectors 208, 210 with the mating connectors 46, 48, including electromagnets on the surface assembly 26 and/or the upper frame 14, 184. The controller 230 includes a processor 240, a memory 242, and other control circuitry. Instructions or routines 244 are stored in the memory 242 and executable by the processor 240. The controller 230 may include communication circuitry 246 for bidirectional wired and wireless communication.

The controller 230 may activate the electromagnets in response to an input by the caregiver in the user interface 220. The caregiver may position the surface assembly 26 on the upper frame 14, 184, couple the electrical connectors 232, 234, and input the command on the user interface 220 to activate the electromagnets. The user interface 220 may also be on a remote device that is in wireless communication with the controller 230 without departing from the teachings herein.

Additionally or alternatively, the controller 230 may be configured to automatically activate the electromagnets based on the routines 244 and may also automatically adjust the covers 156. The controller 230 may include routines 244 (e.g., software or algorithms) that automatically trigger activation of the electromagnets upon electrical communication being established between the surface assembly 26 and the frame assembly 12, 180. Stated differently, when the electrical connector 232 of the surface assembly 26 is connected to the electrical connector 234 of the frame assembly 12, 180, the controller 230 may recognize the connection and trigger activation of the electromagnets. This may be advantageous for maximizing the efficiency of the surface installation process. Further, this communication may allow the controller 230 to recognize and control the components of the surface assembly 26, such as the MCM layer, the pneumatic system 92, retracting assemblies 150, etc.

In examples where the controller 230 is configured to control the attachment system 90 and/or the surface assembly 26 in response to an input in the user interface 220 of a remote device, the controller 230 is configured to communicate with remote or external components, such as the remote device, via a wireless communication network. The communication network may be part of a network of the medical facility, which may include a combination of wired connections (e.g., Ethernet), as well as wireless connections, which may include the wireless communication network. The communication network may include a variety of electronic devices, which may be configured to communicate over various wired or wireless communication protocols. The communication network may include a wireless router through which the remotely accessed devices may be in communication with one another as well as a local server.

The communication network may be implemented via one or more direct or indirect nonhierarchical communication protocols, including but not limited to, Bluetooth®, Bluetooth® low energy (BLE), Thread, Ultra-Wideband, Z-wave, ZigBee, etc. Additionally, the communication network may correspond to a centralized or hierarchal communication network where one or more of the devices communicate via the wireless router (e.g., a communication routing controller). Accordingly, the communication network may be implemented by a variety of communication protocols, including, but not limited to, global system for mobile communication (GSM), general packet radio services, code division multiple access, enhanced data GSM environment, fourth generation (4G) wireless, fifth generation (5G) wireless, Wi-Fi, world interoperability for wired microwave access (WiMAX), local area network, Ethernet, etc. By flexibly implementing the communication network, the various devices and servers may be in communication with one another directly via the wireless communication network, or cellular data connection.

In certain aspects, the controller 230 may be capable of communicating wirelessly via a wireless communication module. The wireless communication module generally communicates via an SPI link with circuitry associated with the support apparatus 10 (e.g., the communication circuitry 246) and the wireless 802.11 link with wireless access points. The wireless access points are generally coupled to Ethernet switches via 802.3 links. It is contemplated that the wireless communication modules may communicate with the wireless access points via any of the wireless protocols disclosed herein. Additionally or alternatively, the Ethernet switches may generally communicate with Ethernet via an 802.3 link. Ethernet is also in communication with the local server, allowing information and data to be communicated to and from the controller 230.

With reference still to FIGS. 1-17, the attachment system 90 disclosed herein generally reduces coupling components between the surface assembly 26 and the frame assembly 12, 180. In certain aspects, there may be no or minimal components of the attachment system 90 between the bottom surface 114 of the outer ticking 28 and the upper support surface 18. In other examples, the straps 30 extend between the support surface 18 and the bottom surface 114 of the outer ticking 28. In such examples, the straps 30 have a thickness of less than about one millimeter and are generally about one or two inches wide and, consequently, do not create substantial pressure points for the patient.

Other systems generally utilize knobs to attach the mattress to the frame. When improperly or not fully installed, the knobs have a height (extending from the surface of the frame), which may create pressure points on the patient. The improperly installed knobs may cause damage to the mattress over time and can result in pressure injuries or discomfort to the patient. Further, the knob components are manually attached by the caregiver.

The attachment system 90 disclosed herein results in no or minimal features between the surface assembly 26 and the frame assembly 12, 180. The features disposed between the surface assembly 26 and the frame assembly 12, 180 are wide and thin to avoid significant pressure on the patient that could lead to discomfort or pressure injury development.

Additionally, other conventional attachment designs, such as the knobs, generally do not allow the mattress to move relative to the frame. Accordingly, then the frame moves, such as to a sitting position, the mattress bunches at the seat region of the patient. This bunching can cause discomfort, such as in the form of top or lateral strain relative to the skin of the patient. The attachment system 90 disclosed herein utilizes the straps 30 and/or the slots 190, 192 to retain the coupling engagement of the surface assembly 26 on the frame assembly 12, 180, while allowing the predefining sliding movement of the surface assembly 26.

For example, the engagement provided by the attachment system 90 is advantageous for when the upper frame 14, 184 is moved relative to the base frame 16, 182. When the segments 60, 62, 64 of the upper frame 14, 184 articulate relative to one another, the surface assembly 26 is also moved between the different positions with the frame assembly 12, 180. The surface assembly 26 remains coupled to the upper frame 14, 184 to continue to support a patient in multiple positions and/or provide various therapies. The surface assembly 26 may slide a predefined distance relative to the support surface 18 to provide additional comfort to the patient while maintaining positioning to provide various therapies. This sliding movement generally occurs at a chest region of the surface assembly 26 along the head and chest segment 60 of the upper frame 14, 184. This movement can also occur at the foot segment 64 based on the articulation of the upper frame 14, 184.

The length of the straps 30 and the length of the slots 190, 192 allows the surface assembly 26, or a portion of the surface assembly 26, to move a predefined amount or distance as the upper frame 14, 184 articulates between various positions. This movement maintains the proper positioning of the surface assembly 26 to the frame assembly 12, 180 and the patient to provide various therapies and treatment. Moreover, the sliding movement may be less than about five inches of movement. For example, in comparison to conventional attachment designs, with the disclosed attachment system 90, when the head end segment 60 is rotated and raised, increasing a head of bed position, the surface assembly 26 can slide relative to the support surface 18 while keeping the engagement between the mating connectors 46, 48 to reduce or eliminate the bunching at the seat region on the upper frame 14, 184 (e.g., at an area proximate to the joint between the head segment 60 and the seat segment 62).

Moreover, the attachment system 90 may provide feedback to the caregiver on the engagement between the strap connectors 40, 42 and the mating connectors 46, 48. Visible feedback can be provided based on the location of the mating connectors 46, 48 and, consequently, the engagement location between the strap connectors 40, 42 and the mating connectors 46, 48. Further, with the surface assembly 26 being electrically coupled with the frame assembly 12, 180, feedback may be provided via the user interface 220 or wirelessly communicated to the remote device.

Referring still to FIGS. 1-17, in various aspects, the attachment system 90 may provide for the automatic installation of the surface assembly 26 with the frame assembly 12, 180. The attachment system 90 may be configured to pull the straps 30 into engagement with the mating connectors 46, 48 without significant manual movement of the straps 30 by the caregiver. Further, the attachment system 90 may include the retracting assemblies 150 to adjust the length of the straps 30 for proper engagement with the mating connectors 46, 48, for placing the straps 30 under tension to secure the surface assembly 26, and for reducing or eliminating excess length of the straps 30. Shorter straps 30 can decrease the risk of straps 30 getting caught or impinging on the frame assembly 12, 180. Further, shorter straps 30 are generally used with more accessible locations of the mating connectors 46, 48, which can make installation and detachment of the surface assembly 26 more convenient and efficient for the caregiver.

The attachment system 90 may also include locating features for the mating connectors 46, 48. The locating features may assist the caregiver in locating the mating connectors 46, 48. This configuration may be particularly advantageous for the configuration where the frame connectors 130, 132 are disposed on the lower surface 20 of the upper frame 14, 184 or on the bottom surface 114 of the outer ticking 28, where the caregiver may have less visibility of the mating connectors 46, 48. These locating features may be visible, haptic, and/or audible to assist the caregiver in locating the mating connectors 46, 48 or that the strap connectors 40 are in close proximity (e.g., within a predefined distance) of the mating connectors 46, 48.

Additionally, while the support apparatus 10 is illustrated as the medical bed, the support apparatus 10 may have a variety of configurations such as a surgical table, stretcher, transport bed, MedSurg bed, etc. Each of the various configurations of the support apparatus 10 may include the frame connectors 130, 132 and/or the slots 190, 192 to allow the surface assembly 26 to be selectively interchanged between various types of support apparatuses 10 using the attachment system 90. Further, the surface assembly 26 may be usable with different mating connectors 46, 48 or locations of mating connectors 46, 48 on different styles and types of support apparatuses 10. The attachment system 90 provides for an interchangeable system of the surface assembly 26 on various support apparatuses 10. The straps 30 generally extend around the side surfaces 22, 24 of the upper frame 14, 184 but may additionally or alternatively extend around the end surfaces 80, 82 depending on the configuration of the support apparatus 10.

The attachment system 90 is advantageous for properly installing the surface assembly 26 and frame assembly 12, 180 to provide the selected treatment for the patient, as well as align the electrical connectors 232, 234. For example, when the pneumatic system 92 is being used, the various bladders are arranged in specific locations in the surface assembly 26 to provide therapies. The proper alignment of the surface assembly 26 to the frame assembly 12, 180 allows for the proper alignment between the patient and the surface assembly 26. Further, this relationship between the patient, the surface assembly 26, and frame assembly 12, 180 is maintained as the upper frame 14, 184 articulates between different positions, but also allows slight sliding to prevent bunching of the surface assembly 26. The proper installation of the surface assembly 26 is advantageous for maximizing functionality from the surface assembly 26 for the patient.

Use of the present device may provide for a variety of advantages. For example, the attachment system 90 retains engagement between the surface assembly 26 and the frame assembly 12, 180. Further, the surface assembly 26 may be interchangeably used with various types and configurations of support apparatuses 10. Moreover, the attachment system 90 is low-profile, minimizing or reducing pressure injury development for the patient and any impingement on the workflow of the caregiver and the functionality of the frame assembly 12, 180. Further, the attachment system 90 provides a flexible engagement between the surface assembly 26 and the frame assembly 12, 180, which allows the surface assembly 26 to slide as upper frame 14, 184 articulates to prevent bunching at bend joints of the surface assembly 26. Additional benefits and advantages may be realized and/or achieved.

The controller 230 disclosed herein may include various types of control circuitry, digital or analog, and may each include the processor 240, a microcontroller, an application specific integrated circuit (ASIC), or other circuitry configured to perform the various inputs or outputs, control, analysis, or other functions described herein. The memory 242 described herein may be implemented in a variety of volatile and nonvolatile memory formats. Routines 244 may include operating instructions to enable the various methods described herein.

The system disclosed herein is further summarized in the following paragraphs and is further characterized by combinations of any and all of the various aspects described therein.

According to another aspect of the present disclosure, a patient support apparatus includes a frame assembly that includes an upper frame having an upper support surface, a lower surface, and first and second side surfaces extending between the upper support surface and the lower surface. A surface assembly is positioned on the upper support surface. The surface assembly includes an outer ticking, first straps extending from the outer ticking proximate to a head end of the surface assembly, second straps extending from the outer ticking proximate to a foot end of the surface assembly, and a strap connector coupled to a distal end of each of the first and second straps. Mating connectors are coupled to at least one of the upper frame and the outer ticking. The first and second straps are configured to extend along the first and second side surfaces to engage with the mating connectors to couple the surface assembly to the upper frame. An engagement between the strap connectors and the mating connectors is maintained while permitting a sliding engagement between the upper support surface and the outer ticking as the upper frame articulates between multiple positions.

According to another aspect of the present disclosure, an upper frame includes a head end segment and a seat segment. Multiple positions include a raised head of bed position when the head end segment is rotated relative to the seat segment. An engagement is configured to permit a sliding engagement as the head end segment is rotated to reduce bunching of a surface assembly at a bend between the head end segment and the seat segment.

According to another aspect of the present disclosure, mating connectors are coupled to a lower surface. First straps and second straps extend from an outer ticking, along first and second side surfaces, and along a lower surface to engage the mating connectors.

According to another aspect of the present disclosure, mating connectors are coupled to first and second side surfaces of an upper frame. First straps and second straps extend from an outer ticking and along first and second side surfaces to engage the mating connectors.

According to another aspect of the present disclosure, first straps and second straps extend from side surfaces of an outer ticking.

According to another aspect of the present disclosure, first straps and second straps extend from a bottom surface of an outer ticking.

According to another aspect of the present disclosure, strap connectors and mating connectors are hook-and-loop fasteners.

According to another aspect of the present disclosure, mating connectors are magnets.

According to another aspect of the present disclosure, mating connectors are magnets and strap connectors are at least one of magnets and a metal feature.

According to another aspect of the present disclosure, a cover is operably coupled to an upper frame. Magnets are coupled to an upper frame. The cover is configured to selectively extend over the magnets to form a barrier for magnetic fields of the magnets.

According to another aspect of the present disclosure, a cover is operably coupled to an upper frame. Mating connectors configured as magnets are coupled to an upper frame. The cover is configured to selectively extend over the magnets to form a barrier for magnetic fields of the magnets.

According to another aspect of the present disclosure, strap connectors are at least one of magnets and a metal feature.

According to another aspect of the present disclosure, magnetic fields extend to first and second side surfaces. Strap connectors are engaged by magnetic fields when a surface assembly is positioned on an upper support surface to be automatically attracted to and engaged with the mating connectors.

According to another aspect of the present disclosure, mating connectors are coupled to an upper frame. The mating connectors are electromagnets.

According to another aspect of the present disclosure, a controller is operably coupled to a frame assembly. A surface assembly includes an electrical connector that engages an electrical connector of the frame assembly to provide communication between the controller and the surface assembly. The controller is configured to activate electromagnets upon an engagement between an electrical connector of the frame assembly with an electrical connector of the surface assembly.

According to another aspect of the present disclosure, a controller is operably coupled to a frame assembly. Mating connectors are electromagnets. A surface assembly includes an electrical connector that engages an electrical connector of the frame assembly to provide communication between the controller and the surface assembly. The controller is configured to activate the electromagnets upon an engagement between an electrical connector of the frame assembly with an electrical connector of the surface assembly.

According to another aspect of the present disclosure, an upper frame defines slots. First straps and second straps are configured to extend through the slots to engage mating connectors.

According to another aspect of the present disclosure, mating connectors are coupled to a proximal portion of first straps and second straps. The first straps and the second straps extend through slots and along first and second side surfaces to engage the mating connectors.

According to another aspect of the present disclosure, retracting assemblies are operably coupled to first straps and second straps. The retracting assemblies are configured to adjust lengths of the first straps and the second straps relative to an outer ticking.

According to another aspect of the present disclosure, retracting assemblies are operably coupled to an outer ticking. The retracting assemblies are configured to retract first and second straps into a surface assembly.

According to another aspect of the present disclosure, first straps and second straps are radio frequency welded to an outer ticking to form seams free of apertures.

According to another aspect of the present disclosure, a patient support apparatus includes an upper frame defining a first slot and a second slot. The upper frame includes an upper support surface and a lower surface. A surface assembly is positionable on the upper support surface. The surface assembly includes an outer ticking. A first strap extends from the outer ticking. A second strap extends from the outer ticking. The first strap is on an opposing side of a centerline of the surface assembly compared to the second strap. A strap connector is coupled to a distal end of each of the first strap and the second strap. The first strap extends through the first slot to engage a first mating connector and the second strap extends through the second slot to engage a second mating connector to couple the surface assembly to the upper frame.

According to another aspect of the present disclosure, a first strap and a second strap extend from a bottom surface of an outer ticking, through first and second slots, along a lower surface, and along first and second side surfaces of an upper frame.

According to another aspect of the present disclosure, a first strap and a second strap extend from a bottom surface, through first and second slots, along a lower surface, and along first and second side surfaces of an upper frame.

According to another aspect of the present disclosure, first and second mating connectors are coupled to first and second side surfaces of an outer ticking.

According to another aspect of the present disclosure, first and second mating connectors are coupled to proximal portions of first and second straps.

According to another aspect of the present disclosure, a first strap and a second strap extend from a bottom surface, along an upper support surface, along first and second side surfaces of an upper frame, along a lower surface, and through first and second slots.

According to another aspect of the present disclosure, first and second mating connectors are coupled to a bottom surface of an outer ticking.

According to another aspect of the present disclosure, first and second straps loop around first and second side surfaces of an upper frame and through first and second straps.

According to another aspect of the present disclosure, a first slot and a second slot extend between a head end and a foot end of an upper frame.

According to another aspect of the present disclosure, a first slot and a second slot extend between a head end and a foot end of an upper frame. An upper frame includes a head end segment, a foot end segment, and a base segment. The first slot and the second slot are defined in the head end segment.

According to another aspect of the present disclosure, an upper frame includes a head end segment, a foot end segment, and a base segment. A first slot and a second slot are defined in the head end segment.

According to another aspect of the present disclosure, a third slot and a fourth slot are defined in a foot segment.

According to another aspect of the present disclosure, a surface assembly includes a third strap configured to extend through a third slot and a fourth strap configured to extend through a fourth slot.

According to another aspect of the present disclosure, a third slot and a fourth slot are defined in a foot segment, and a surface assembly includes a third strap configured to extend through the third slot and a fourth strap configured to extend through the fourth slot.

According to another aspect of the present disclosure, an engagement between strap connectors and mating connectors is maintained while permitting a sliding engagement between a surface assembly and an upper support surface as a head end segment is rotated relative to a base segment to reduce bunching of the surface assembly at a bend between the head end segment and the base segment.

According to another aspect of the present disclosure, a patient support apparatus includes a frame assembly including a base frame. An upper frame is operably coupled to the base frame. The upper frame includes an upper support surface, a lower surface opposing the upper support surface, and first and second lateral side surfaces extending between the upper support surface and the lower surface. First and second frame connectors are coupled to the lower surface. A surface assembly is positioned on the upper support surface. The surface assembly includes an outer ticking. A first strap is coupled to the outer ticking. A first connector is coupled to a distal end of the first strap. A second strap is coupled to the outer ticking. A second connector is coupled to a distal end of the second strap. The first strap extends from the outer ticking, along the first side surface, and along the lower surface to engage the first frame connector, and the second strap extends from the outer ticking, along the second side surface, and along the lower surface to engage the second frame connector to couple the surface assembly to the upper frame.

According to another aspect of the present disclosure, a first strap and a second strap are coupled to an outer ticking via radio frequency welding.

According to another aspect of the present disclosure, a first frame connector is on a first side of a centerline of an upper frame and a second frame connector is on a second side of the centerline, and the first and second frame connectors are closer to first and second side surfaces, respectively, than the centerline.

According to another aspect of the present disclosure, a first frame connector is on a first side of a centerline of an upper frame and a second frame connector is on a second side of the centerline.

According to another aspect of the present disclosure, first and second frame connectors are closer to first and second side surfaces, respectively, than a centerline.

According to another aspect of the present disclosure, first and second frame connectors are coupled to a lower surface adjacent to first and second side surfaces.

According to another aspect of the present disclosure, first and second frame connectors are at least one of magnets, hook fasteners, loop fasteners, and electromagnets.

According to another aspect of the present disclosure, first and second frame connectors are magnets.

According to another aspect of the present disclosure, a frame assembly includes covers configured to extend over the magnets to provide barriers for magnetic fields of the magnets.

According to another aspect of the present disclosure, the frame assembly includes covers configured to extend over first and second strap connectors engaged with magnets.

According to another aspect of the present disclosure, first and second frame connectors are one of hook fasteners and loop fasteners.

According to another aspect of the present disclosure, first and second straps are constructed of an elastic material.

According to another aspect of the present disclosure, a retracting assembly is operably coupled to first and second straps to adjust lengths of the first and second straps relative to an outer ticking.

According to another aspect of the present disclosure, first and second straps extend from a bottom surface of an outer ticking.

According to another aspect of the present disclosure, a patient support apparatus includes a frame with a support surface and a lower surface opposing the support surface. A surface assembly includes an outer ticking. The surface assembly is configured to be positioned on the frame. An attachment system includes straps extending from the surface assembly, strap connectors coupled to the straps, and frame connectors coupled to opposing sides of the frame. The straps are configured to extend from the surface assembly and along opposing side surfaces, respectively, of the frame to engage the frame connectors.

According to another aspect of the present disclosure, a surface assembly for a patient support apparatus includes an outer ticking having a head end and a foot end. First straps extend from opposing sides of the outer covering. The first straps are welded to the outer ticking. The first straps are disposed proximate to the head end. First strap connectors are coupled to distal ends of the first straps. Second straps extend from the opposing sides of the outer ticking. The second straps are welded to the outer ticking. The second straps are disposed proximate to the foot end. Second strap connectors are coupled to distal ends of the second straps. The first strap connectors are configured to engage the second strap connectors adjacent to a lower surface of an upper frame of said patient support apparatus.

According to another aspect of the present disclosure, a surface assembly for a patient support apparatus that includes a frame with first and second slots where the surface assembly includes an outer ticking having a head end and a foot end. A first strap extends from the outer covering. The first strap is welded to the outer ticking. A first strap connector is coupled to a distal end of the first strap. A first proximal connector is coupled to a proximal portion of the first strap. The first strap is configured to extend through said first slot for the first strap connector to engage the first proximal connector around said frame. A second strap extends from the outer ticking. The second strap is welded to the outer ticking. A second strap connector is coupled to a distal end of the second strap. A second proximal connector is coupled to a proximal portion of the second strap. The second strap is configured to extend through said second slot for the second strap connector to engage the second proximal connector around said frame.

According to another aspect of the present disclosure, a surface assembly for a patient support apparatus having frame connectors where the surface assembly includes an outer ticking having a head end and a foot end. First straps extend from opposing sides of the outer covering. The first straps are welded to the outer ticking. The first straps are disposed proximate to the head end. First surface connectors are coupled to distal ends of the first straps. Second straps extend from the opposing sides of the outer ticking. The second straps are welded to the outer ticking. The second straps are disposed proximate to the foot end. Second surface connectors are coupled to distal ends of the second straps. The first surface connectors and the second surface connectors are configured to engage said frame connectors of said patient support apparatus.

A means for supporting a patient includes a support means with an upper frame having an upper support surface, a lower surface, and first and second side surfaces extending between the support surface and the lower surface. A surface means is positioned on the upper support surface. The surface means includes an outer cover means, first coupling means extending from the outer cover means proximate to a head end of the surface means, and second coupling means extending from the outer cover means proximate to a foot end of the surface means. First means for connecting are coupled to distal ends of the first and second coupling means. Second means for connecting are coupled to at least one of the upper frame and the outer cover means. The first and second coupling means are configured to extend along the first and second side surfaces to engage with the second means for connecting to couple the surface means to the upper frame. An engagement between the first means for connecting and the second means for connecting is maintained while permitting a sliding engagement between the upper support surface and the outer cover means as the upper frame articulates between multiple positions.

Related applications, for example those listed herein, are fully incorporated by reference. Assertions within the related applications are intended to contribute to the scope and interpretation of the information disclosed herein. Any changes between any of the related applications and the present disclosure are not intended to limit the scope or interpretation of the information disclosed herein, including the claims. Accordingly, the present application includes the scope and interpretation of the information disclosed herein as well as the scope and interpretation of the information in any or all of the related applications.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, are illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A patient support apparatus, comprising:
a frame assembly including an upper frame having an upper support surface, a lower surface, and first and second side surfaces extending between the support surface and the lower surface;
a surface assembly positioned on the upper support surface, wherein the surface assembly includes:
an outer ticking;
first straps extending from the outer ticking proximate to a head end of the surface assembly;
second straps extending from the outer ticking proximate to a foot end of the surface assembly; and
a strap connector coupled to a distal end of each of the first and second straps, respectively; and
mating connectors coupled to at least one of the upper frame and the outer ticking, wherein the first and second straps are configured to extend along the first and second side surfaces to engage with the mating connectors to couple the surface assembly to the upper frame, and wherein an engagement between the strap connectors and the mating connectors is maintained while permitting a sliding engagement between the upper support surface and the outer ticking as the upper frame articulates between multiple positions.

2. The patient support apparatus of claim 1, wherein the mating connectors are coupled to the lower surface, and wherein the first straps and the second straps extend from the outer ticking, along the first and second side surfaces, and along the lower surface to engage the mating connectors.

3. The patient support apparatus of claim 1, wherein the mating connectors are coupled to the first and second side surfaces of the upper frame, and wherein the first straps and the second straps extend from the outer ticking and along the first and second side surfaces to engage the mating connectors.

4. The patient support apparatus of claim 1, wherein the mating connectors are magnets, and wherein the strap connectors are at least one of magnets and metal features.

5. The patient support apparatus of claim 4, further comprising:
a cover operably coupled to the upper frame, wherein the mating connectors are coupled to the upper frame, and wherein the cover is configured to selectively extend over the mating connectors to form a barrier for magnetic fields.

6. The patient support apparatus of claim 5, wherein the magnetic fields extend to the first and second side surfaces, respectively, and wherein the strap connectors are engaged by the magnetic fields when the surface assembly is positioned on the upper support surface to be automatically attracted to and engaged with the mating connectors.

7. The patient support apparatus of claim 1, further comprising:
a controller operably coupled to the frame assembly, wherein the mating connectors are electromagnets, and wherein the surface assembly includes an electrical connector that engages an electrical connector of the frame assembly to provide communication between the controller and the surface assembly, and further wherein the controller is configured to activate the electromagnets upon an engagement between the electrical connector of the frame assembly with the electrical connector of the surface assembly.

8. The patient support apparatus of claim 1, wherein the upper frame defines slots, and wherein the first straps and the second straps are configured to extend through the slots to engage the mating connectors.

9. The patient support apparatus of claim 8, wherein the mating connectors are coupled to a proximal portion of the first straps and the second straps, respectively, and wherein the first straps and the second straps extend through the slots and along the first and second side surfaces to engage the mating connectors.

10. The patient support apparatus of claim 1, further comprising:
retracting assemblies operably coupled to the first straps and the second straps, wherein the retracting assemblies are configured to adjust lengths of the first straps and the second straps relative to the outer ticking.

11. A patient support apparatus, comprising:
an upper frame defining a first slot and a second slot, wherein the upper frame includes an upper support surface and a lower surface;
first and second mating connectors; and
a surface assembly positionable on the upper support surface, wherein the surface assembly includes:
an outer ticking;
a first strap extending from the outer ticking;
a second strap extending from the outer ticking, the first strap being on an opposing side of a centerline of the surface assembly compared to the second strap; and
a strap connector coupled to a distal end of each of the first strap and the second strap, wherein the first strap extends through the first slot to engage the first mating connector and the second strap extends through the second slot to engage the second mating connector to couple the surface assembly to the upper frame.

12. The patient support apparatus of claim 11, wherein the first strap and the second strap extend from a bottom surface of the outer ticking, through the first and second slots, along the lower surface, and along first and second side surfaces, respectively, of the upper frame.

13. The patient support apparatus of claim 11, wherein the first and second mating connectors are coupled to the outer ticking.

14. The patient support apparatus of claim 11, wherein the first slot and the second slot extend between a head end and a foot end of the upper frame, and wherein the upper frame includes a head end segment, a foot end segment, and a base segment, and further wherein the first slot and the second slot are defined in the head end segment.

15. The patient support apparatus of claim 14, wherein a third slot and a fourth slot are defined in the foot segment, and wherein the surface assembly includes a third strap configured to extend through the third slot and a fourth strap configured to extend through the fourth slot.

16. The patient support apparatus of claim 14, wherein an engagement between the strap connectors and the first and second mating connectors is maintained while permitting a sliding engagement between the surface assembly and the upper support surface as the head end segment is rotated relative to the base segment to reduce bunching of the surface assembly at a bend between the head end segment and the base segment.

17. A patient support apparatus, comprising:
a frame assembly including:
a base frame;
an upper frame operably coupled to the base frame, wherein the upper frame includes an upper support surface, a lower surface opposing the upper support surface, and first and second lateral side surfaces extending between the upper support surface and the lower surface; and
first and second frame connectors coupled to the lower surface; and
a surface assembly positioned on the upper support surface, wherein the surface assembly includes:
an outer ticking;
a first strap coupled to the outer ticking;
a first strap connector coupled to a distal end of the first strap;
a second strap coupled to the outer ticking; and
a second strap connector coupled to a distal end of the second strap, wherein the first strap extends from the outer ticking, along the first side surface, and along the lower surface to engage the first frame connector, and wherein the second strap extends from the outer ticking, along the second side surface, and along the lower surface to engage the second frame connector to couple the surface assembly to the upper frame.

18. The patient support apparatus of claim 17, wherein the first strap and the second strap are coupled to the outer ticking via radio frequency welding.

19. The patient support apparatus of claim 17, wherein the first frame connector is on a first side of a centerline of the upper frame and the second frame connector is on a second side of the centerline, and wherein the first and second frame connectors are closer to the first and second side surfaces, respectively, than the centerline.

20. The patient support apparatus of claim 17, wherein the first and second frame connectors are at least one of magnets, hook fasteners, loop fasteners, and electromagnets.
